(19) United States
(12) Patent Application Publication
(10) Pub. No.: US 2007/0136582 A1
(43) Pub. Date: Jun. 14, 2007

(54) METHOD AND SYSTEM FOR TRANSACTION VALIDATION

(76) Inventors: GIUSEPPE LONGOBARDI, C/Mare Di Stabia (NA) (IT); Scot MacLellan, Roma (IT); Fausto Ribechini, Roma (IT)

Correspondence Address: IBM CORPORATION;INTELLECTUAL PROPERTY LAW, 11400 BURNET ROAD, AUSTIN, TX, 78758, US

(21) Appl. No.: 11/564,310

(22) Filed: Nov. 29, 2006

(30) Foreign Application Priority Data
Dec. 13, 2005 (EP) 05112046.7

(51) Int. Cl. H04L 9/00

(52) U.S. Cl. 713/168

(57) ABSTRACT

A method and system of authenticating submissions from a client to a server within a secure session as established for example by entry of username and password data, wherein the session is composed of a number of transactions each of which is itself additionally authenticated, for example by submission of biometric data. Thus each transaction is authenticated both individually and at a session level. In an embodiment the session level authentication may comprise submission of a pin code at am ATM, whilst every subsequent request or instruction from the user could be accompanied by for example fingerprint data from a scanner integrated in the ATM keypad. A session comprises a number of transactions, each of which is individually authenticated. Preferably a session level authentication is carried out at the beginning of a session, from which authority for the following transaction authentications is derived. This may be achieved by comparing transaction authentication information with the authorised session initiating authentication data. Each transaction can be provided with authentication data by recourse to biometric measurements of a user.

Security is key to many human/computer interactions, whether they be to grant different privileges to different categories of user within a data centre, to permit or block personal financial transactions (e.g. credit card purchases on the Internet), to ensure national security by allowing computer-initiated defence actions to be triggered only by vetted individuals, and so on.

FIG. 1 shows an approach known from the prior art. One means by which security is applied is through session-level authentication is shown in FIG. 1. After session initiation (step 502) an individual is ‘authenticated’ (i.e. he/she proves to be who they claim to be through a user id/password combination, passcode, digital certificate, etc. submitted at step 504 and checked at step 506). If the authentication is successful, the individual is then free to perform operations at step 514, that they are permitted to perform for the duration of the ‘session’ or ‘conversation’ that is interrupted by an explicit session end protocol (i.e. log off) or a time-out period, whereupon the session is closed at step 524.

### SUMMARY OF THE INVENTION

The approach described with regard to FIG. 1 can work well, but has a disadvantage for example where an individual opens a session and then leaves a workstation unattended, thereby leaving an opportunity open to have unauthorized individuals perform actions under their authorization, or, once authenticated, they may become targets of aggression by individuals that wish to perform acts that they are not authorized to perform.

An example of the former is a system administrator that wanders off to get a coffee and leaves his/her workstation open to a user that can then maliciously damage the system. An example of the latter is an ATM session that is started by the entry of a correct PIN by the owner of the card, who is then pushed out of the way by an individual that then withdraws cash from the account of the victim.

Another example could be the case of a shared workstation where the userid and password is unique for a pool of users. It is not possible to provide authentication of whichever of the real users belonging to the pool, is requesting the transaction

According to the present invention there is provided a method of authenticating transactions according to the appended independent claim 1, a computer program according to the appended independent claim 15, a computer readable medium according to the appended independent claim 16, a system according to the appended independent claim 17, and a mechanically actuated computer input device according to the appended independent claim 18. Preferred embodiments are defined in the dependent claims.

Further advantages of the present invention will become clear to the skilled person upon examination of the drawings and detailed description. It is intended that any additional advantages be incorporated herein.

### BRIEF DESCRIPTION OF THE DRAWINGS

Embodiments of the present invention will now be described by way of example with reference to the accompanying drawings in which like references denote similar elements, and in which:

FIG. 1 shows an approach known from the prior art;

FIG. 2 shows a first embodiment;

FIG. 3 shows a flow chart of a sequence of steps according to which the system described with regard to FIG. 2 may be implemented;

FIG. 4 shows a second embodiment;

FIG. 5 shows a flow chart of a sequence of steps according to which the system described with regard to FIG. 4 may be implemented;

FIG. 6 shows a transaction authentication failure according to the second embodiment as described with reference to FIG. 4;

FIG. 7 shows a third embodiment;

FIG. 8 shows a flow chart of a sequence of steps according to which aspects the system described with regard to FIG. 7 may be implemented;

FIG. 9 shows a keypad embodying the invention;

FIG. 10 shows a mouse embodying the invention;

FIG. 11 shows a sixth embodiment; and

FIG. 12 shows in greater detail the sixth embodiment.

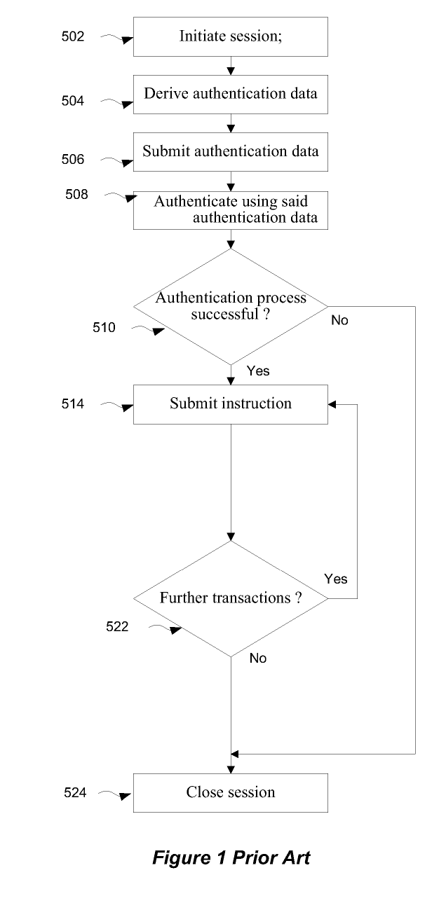

### DETAILED DESCRIPTION

A solid and diffuse base of session-level authentication is built upon by providing a means to ensure that each transaction or operation is triggered by the individual that initiated the session and that therefore is authorized to execute the transaction.

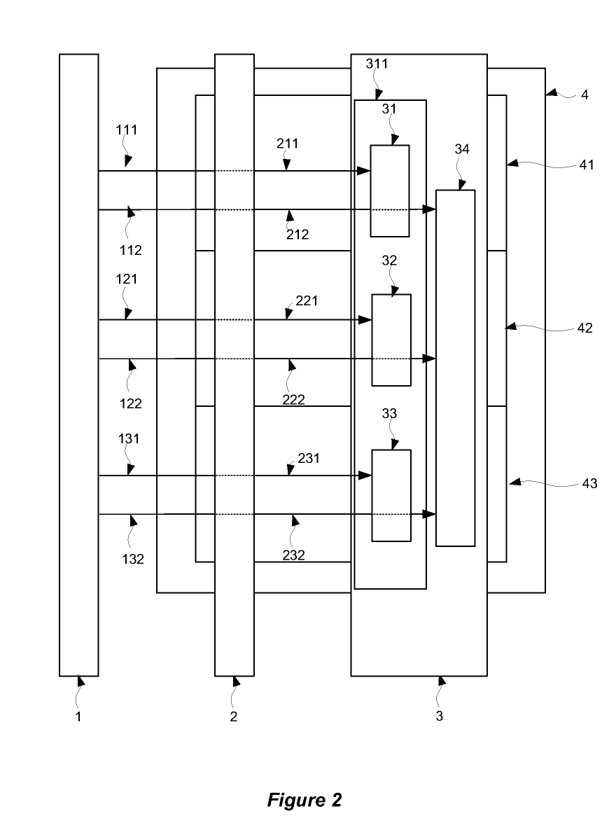

FIG. 2 shows a first embodiment. According to this embodiment, there is provided an interface 2 in communication with a user 1 and a transaction processor 3. In some embodiments the interface 2 may be considered to constitute a client, and the transaction processor a server. Preferably the transaction processor 3 may be considered as a client, with a server not shown. According to this embodiment, the user 1 instigates a number of transactions 41, 42 and 43, each comprising an instruction 211, 221 and 231. An instruction will correspond generally to a single user manipulation apt to provoke a distinct and discrete effect. These instructions are passed on to the transaction processor 3 by the interface 2 in encoded form as messages 211, 221 and 231 respectively. Each of said instructions 112, 122 and 132 is accompanied by authentication data 111, 121 and 131, which in each case is passed on by said interface 2 to the transaction processor 3. Specifically, each instruction preferably arrives at the server substantially simultaneously with its associated authentication data. Ideally the authentication data should be extracted from said user in a manner requiring the minimum of deliberate intervention from the user. The means of extraction chosen will depend on the nature of the transaction itself. According to a preferred embodiment the authentication information 111, 121 and 131 is biometric data. Biometric data may comprise for example any one or more of finger print lines, finger pore structure, relative distance of specific face or hand features, finger measurements, vein structure of the hand, dimensions of the ear, Iris pattern, pattern of the retinal vein structure, voice tone or timbre, DNA, Chemical composition of the user's odour, writing style as a function of pressure and speed or rhythm of keyboard strokes. The extraction of authentication data, such as biometric data is prefereably linked to the initiation of a transaction, and is preferably triggered by the same user action which initiates the transaction.

For each transaction, the transaction processor 3 implements a transaction authentication process 31, 32, 33 respectively, at which the received authentication data 211, 221 and 231 is analysed, for example by comparison to a user database (not shown) containing user authentication information. Where the authentication data is determined to represent a valid user, the corresponding transaction message 212, 222, 232 is passed on for implementation of the transaction.

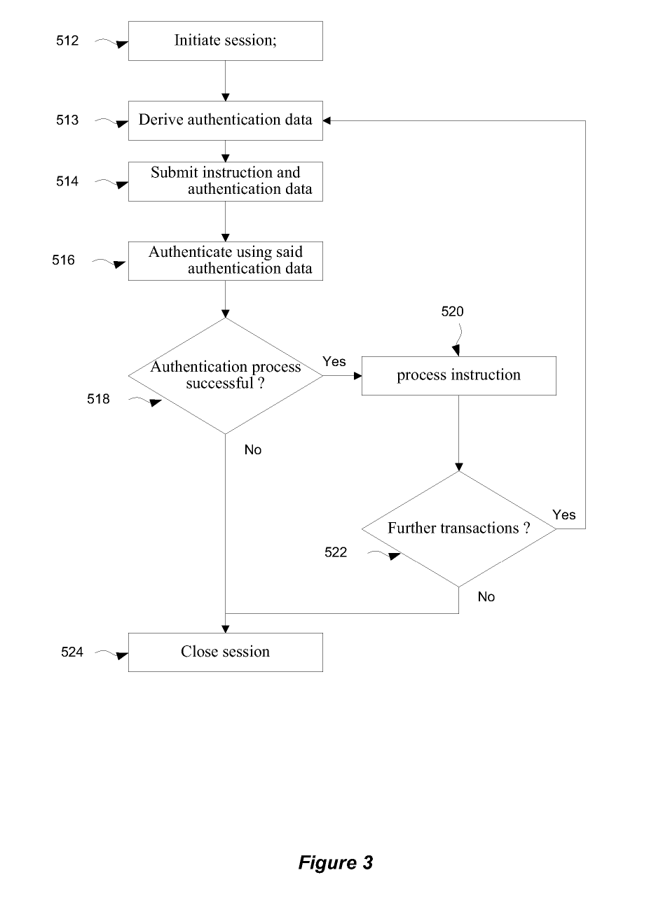

FIG. 3 shows a flow chart of a sequence of steps according to which the system described with regard to FIG. 2 may be implemented. Specifically, FIG. 2 shows a method of authenticating communications between a first entity such as the interface discussed above and a second entity such as the transaction processor discussed above. The method begins with the step 512 of initiating a session. A first transaction begins at step 513 with the derivation of authentication data, corresponding for example to the authentication 111 described above with regard to FIG. 2, according to any suitable means for example as discussed above. This information is then submitted at step 514 along with an instruction or other information relating to a transaction. An authentication process is executed upon the authentication data at step 516, and if the authentication process is successful (step 518) the instruction is duly processed at step 520. Otherwise the session is terminated at step 524. Where the authentication succeeds and an instruction is processed, it is then determined whether further transactions are to be carried out. In a case where further transactions are envisaged, for example where that last instruction received was not an instruction to terminate the session, the process returns to step 513 and the transaction steps repeated. Otherwise the session is closed at step 524 and the process terminates.

Thus each transaction as discussed above can be considered to be made up of the steps of deriving authentication data,

submitting an instruction and said authentication data from the first entity; authenticating the first entity with the second entity by a first authentication process using the authentication data; and where said step of authenticating by a first authentication process is successful, processing the instruction.

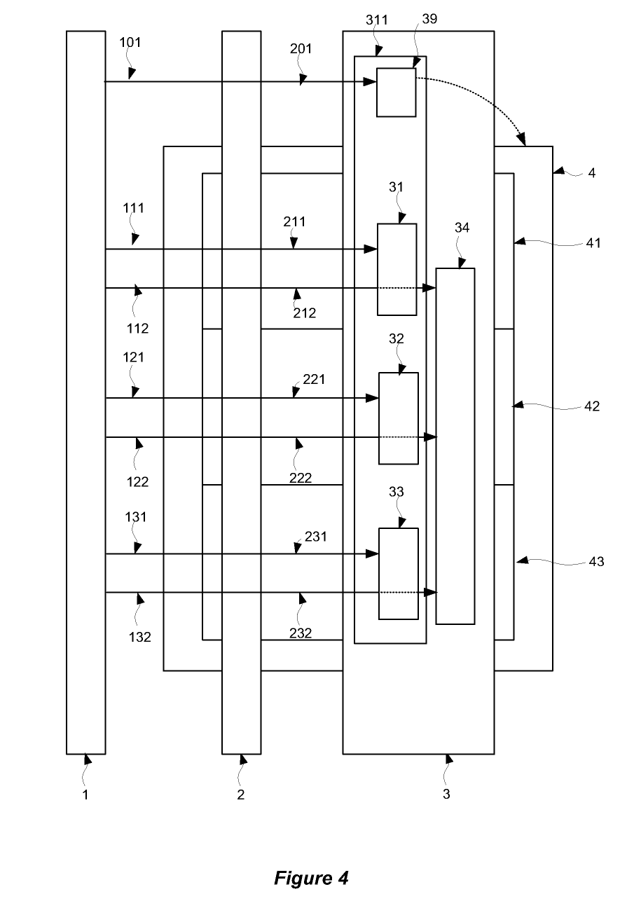

FIG. 4 shows a second embodiment. This embodiment is similar to that of FIG. 2, with the exception that prior to transactions 41, 42 and 43, and their corresponding submissions of instructions and authentication information, session initiating authentication data 101 is submitted by a user 1 to the interface 2, and by the interface 2 to the transaction processor 3 as initiating authentication message 201. This session initiating data is authenticated by the transaction processor 311 in authentication process 39, and where the authentication is successful a session is initiated within which the transactions 41, 42 and 43 take place. In particular, if the authentication of the session initiating data fails, the user will not be permitted to submit instructions, whether accompanied by authenticating data or not.

According to a preferred embodiment, the session initiating data 101 is of a form different to that of the authentication data 111, 121 or 131. In particular, since for a given session the session initiating data is only submitted once, there is less motivation for the derivation of the data to be transparent to the user. The session initiating data may constitute a username and password, and account number and PIN code or any other set of data apt to uniquely identify a user.

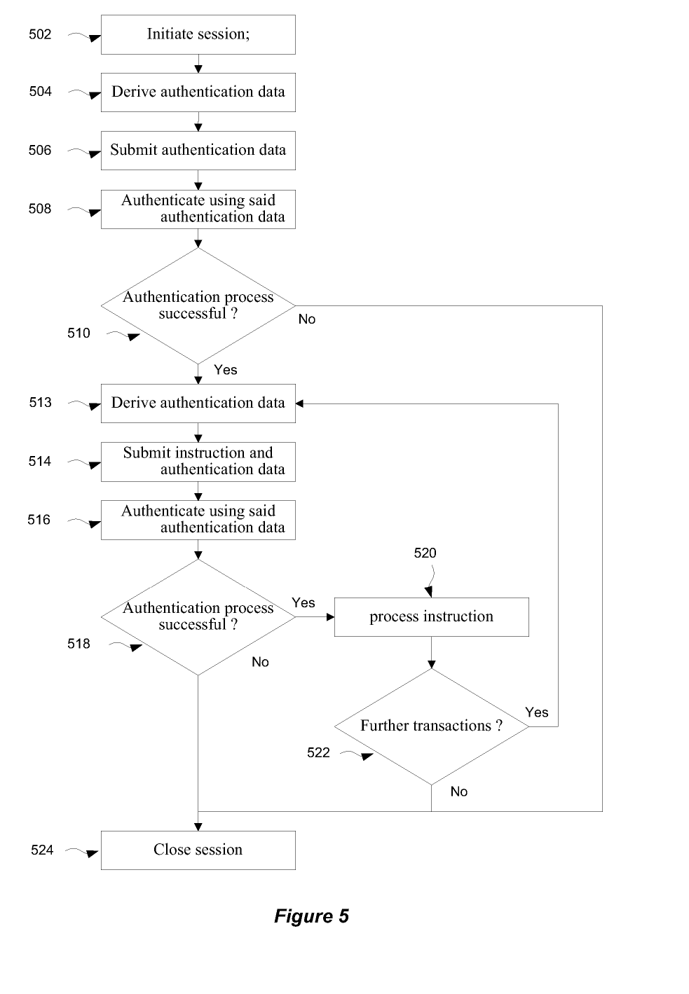

FIG. 5 shows a flow chart of a sequence of steps according to which the system described with regard to FIG. 4 may be implemented. Specifically, FIG. 5 shows the same steps as described with respect to FIG. 3, and further comprises Steps 504, 506, 508 and 510 interposed between step 502 at which a session is initiated, and step 513 at which transaction authentication information is derived, as described above. According to this embodiment, at step 504 session authentication data 101 are derived, which are submitted to the transaction processor at step 506, for authentication at step 508. Only if the authentication of the session authentication information 101 is successful does the method proceed to step 513 as discussed above. Otherwise, the session terminates at step 524 as discussed above.

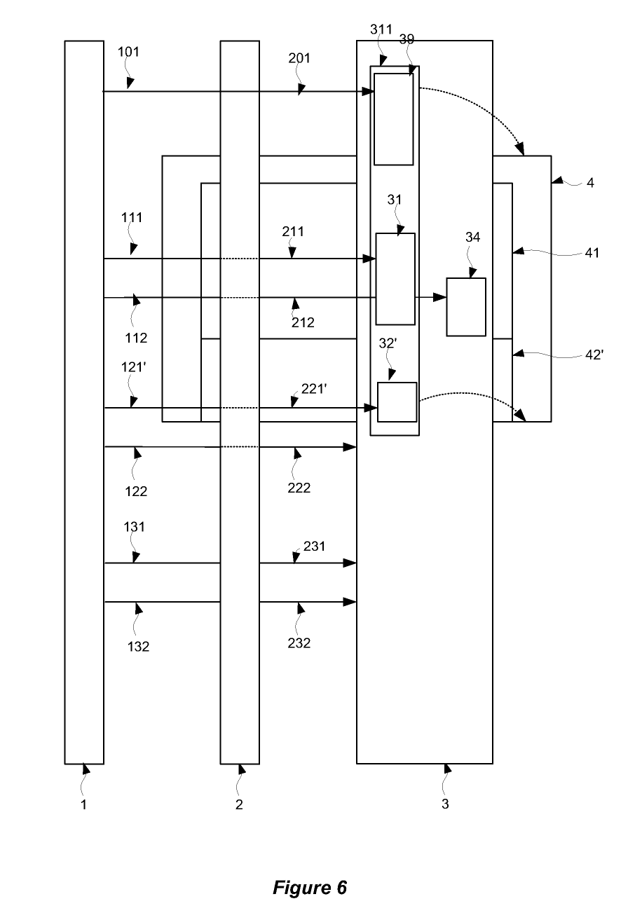

FIG. 6 shows a transaction authentication failure according to the second embodiment as described with reference to FIG. 4. FIG. 6 shows the submission of session initiating authentication data 101 and transaction authenticating data 111 as described with respect to FIG. 4. However, after the completion of the first transaction 41, a new transaction 42′ is begun with the submission of invalid transaction authentication data 121′. This submitted value is passed on by the interface 2 in the usual way as invalid transaction authentication message 221′. This invalid transaction authentication message 221′ is processed by authentication process 32′, which fails to authenticate the user, and accordingly terminates the session, and the transaction. Any instruction e.g. 222 accompanying the invalid transaction authentication message 221′ is thus disregarded, as will be any further transaction messages 231/232. The user can only resume transactions by establishing a new session.

According to certain embodiments, a degree of tolerance may be introduced for failed authentications. Various responses to a failed transaction authentication may be envisaged:
The session is terminated immediately on the failure of any authentication. This approach, which is that described above with respect to FIG. 6, is the most strict and accordingly the most secure. Since some embodiments are realised using biometric information however which is often to some degree variable and difficult to control, this strict approach may limit usability. The following variations may provide more user friendly approaches.
The transaction is aborted, but the session is unaffected so that further transactions may be submitted as usual.
The authentication failure is logged, with a view to terminating the session once a certain number of authentication failures are registered. The transaction in question may or may not be terminated. A number of transaction authentication failures may be disregarded as a proportion of a total number of transactions, or valid authentications may be required only for certain transactions. In this last case, transactions requiring authentication may be selected randomly, or on the basis of the nature of the transaction, or on some other basis.

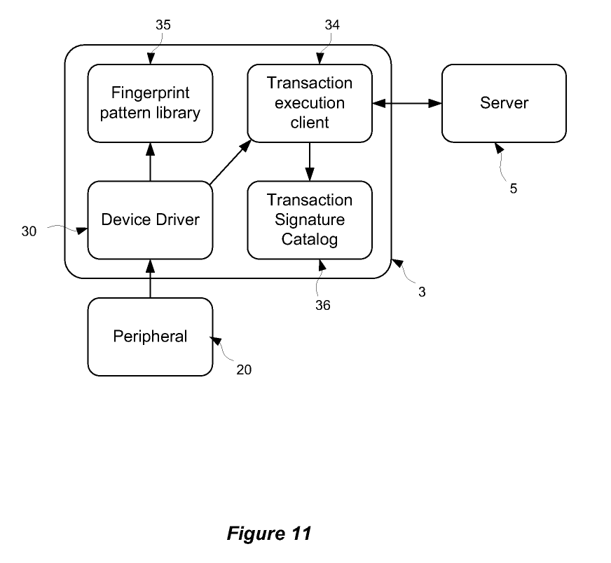

Reaction to an authentication failure may depend on the degree of failure, or by the nature of the accompanying instruction. A protocol may be defined whereby the system combines any or all of the above responses depending on circumstances. Specifically this functionality may be provided by a Transaction Signature catalogue 36 as described below with reference to FIG. 11.

As mentioned above, transaction authentication data is preferably biometric. Session authentication may also be biometric. Biometric information can be unobtrusively extracted from the user by interface elements which the user is obliged to interact in submitting a transaction. For example where a user issues transactions to the interface by means of voice commands, voice biometrics can be derived from the same input. Where a keyboard is used to issue instructions, the user's characteristic typing patterns can be analysed in parallel. It may be appropriate to incorporate a finger print scanner or other detector into a keyboard or other part of the interface with which the user comes into contact at least once per transaction. For example, many types of keyboard or key pad entry require the depression of a “submit” or “enter” key to register entered values as a complete transaction.

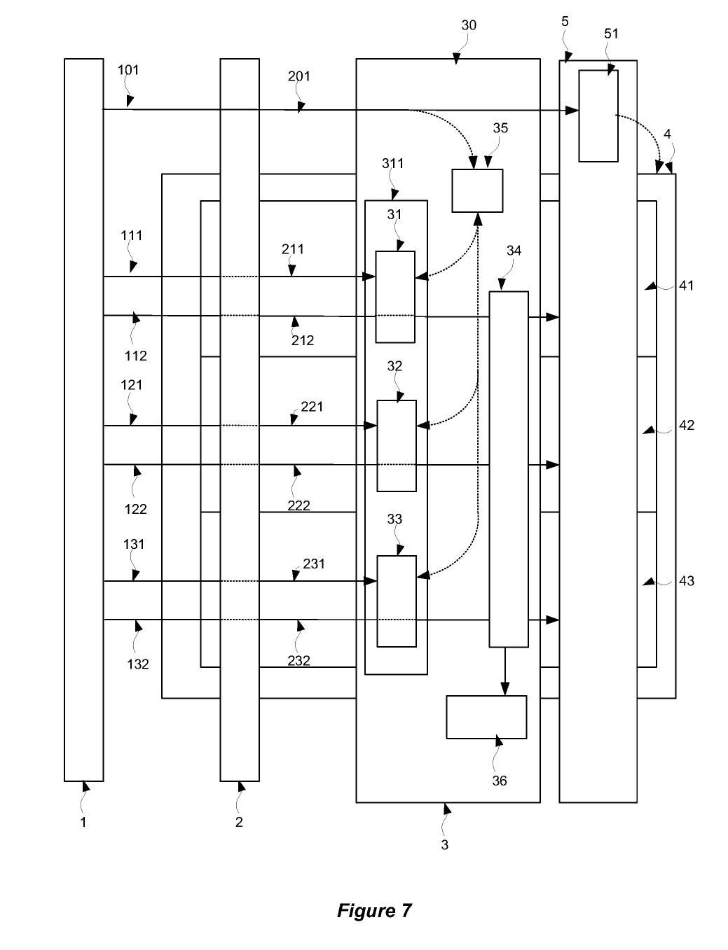

FIG. 7 shows a third embodiment. According to this embodiment, authentication tasks are divided between a client comprising the transaction processor 3 and a server 5. Specifically, initiating authentication message 201 is relayed by the client 3 to a server 5. The Server 5 is provided with a server side, higher level, authentication process 51 which authenticates the initiating message and thereby initiates the session 4. Following instructions can thereafter be authenticated by the client 3 i.e. according to a lower level authentication, in processes 31, 32 and 33, and the instructions forwarded to the sever 5 as necessary.

As shown in FIG. 5, transactions 212, 222, 232 authenticated by the client 3 are relayed to the same server 5 as received and processed the initiating authentication message. Alternatively, a separate authentication server may be provided for receiving and processing the initiating authentication message, and a transaction server for the handling of transactions thereafter.

Preferably, the client is provided with a library 35 for storing authentication messages submitted by the interface 2. In a case where the initiating authentication method is of the same format as transaction authenticating messages, e.g. if all messages are derived form the same biometric, the initiating authentication message is also preferably stored in this library 35. This information is thus available for the authentication of later transactions. Specifically, as shown in FIG. 7 the client side authentication processor 311 is able to access the library 35 in authenticating the transactions 212, 222, 232 at processes 31, 32 and 33 respectively. Where the transactions are authenticated, they are then relayed to the server 5 as discussed above. Thus in other words session initiation authentication is performed, and the biometric data captured at each subsequent transaction is then used to ensure that the user is the same user that initiated the session.

Authentication data, as stored in the library 35, may be stored at a client or at a server, in order to allow for client or server side authentication respectively.

Each transaction authentication is preferably carried out by comparing the transaction authentication message with the initiating authentication data. This approach is advantageous since the authenticity of the initiating authentication data has been established by the server, and is thus more trustworthy. This approach might be referred to as delegated authentication.

This validation is less onerous than a full authentication, avoids continuous requests to the authentication system (often external), and has the benefit that it can also be performed locally at the client system.

The use of a library component to compare authentication attempts with previously submitted authentication data may of course also be used in a case where all authentication is carried out at the client as discussed with respect to FIG. 4 for example.

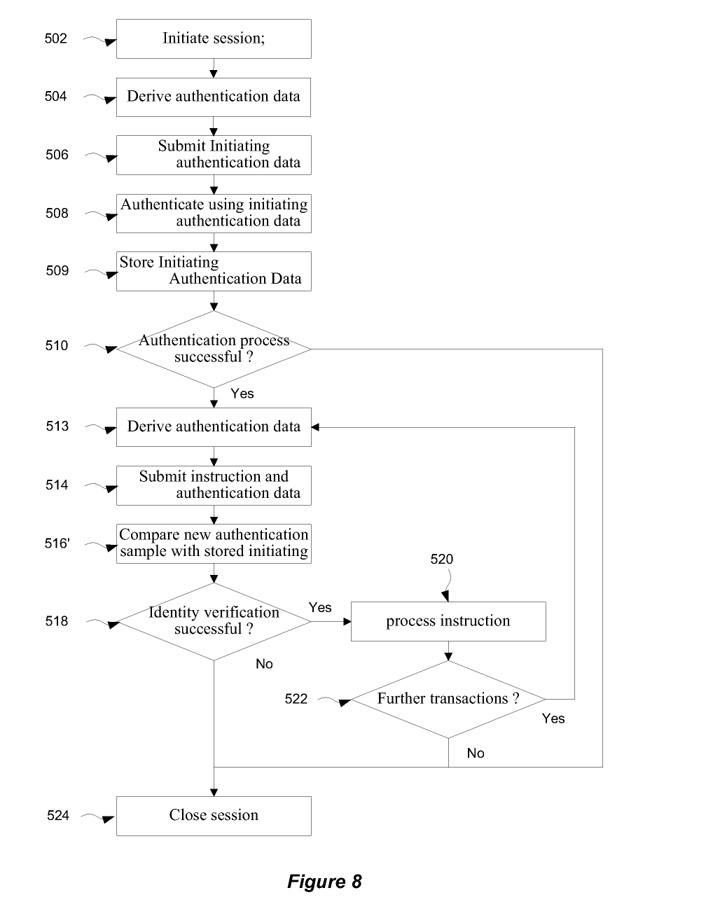

FIG. 8 shows a flow chart of a sequence of steps according to which aspects of the system described with regard to FIG. 7 may be implemented. The steps of this chart correspond to those of FIG. 5, with the exception that there is provided a further step 509 of storing the initiating authentication data. Meanwhile, step 516 is replaced with step 516′, whereby authentication of later authentication messages is carried out with reference to the authentication information stored at step 509.

Certain embodiments employ a peripheral device that is able to recognize the initiator of input actions for example by means of biometric measurements as discussed above.

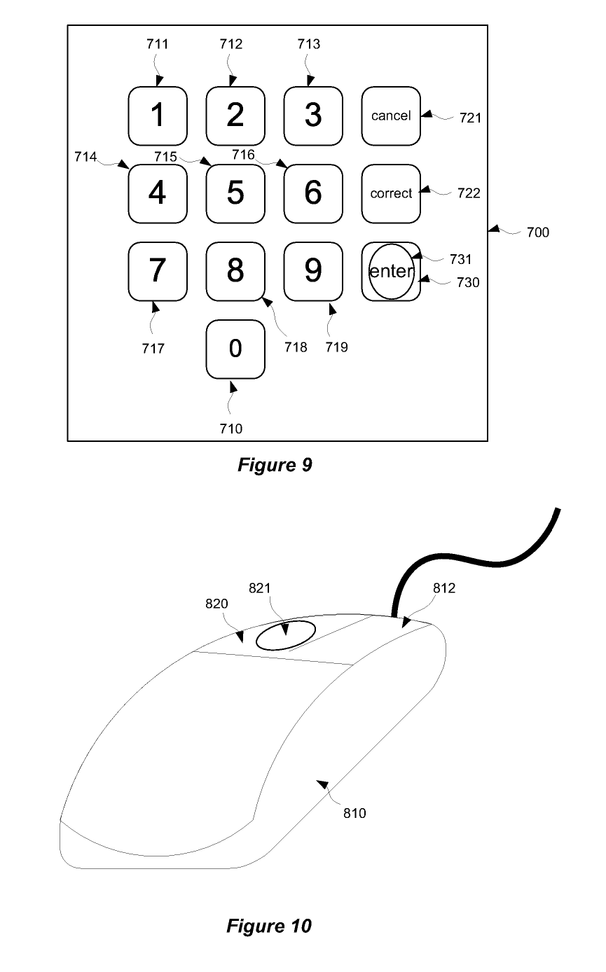

FIG. 9 shows a keypad embodying the invention. Such a keypad may be used for example in ATM machines, in access control (entryphone) interfaces, in “chip and PIN” payment interfaces etc., and comprises a simple numeric keypad having keys numbered 0 to 9 (710-719) as well as keys marked “cancel” 721, “correct” 722 and “enter” 730. Conventionally, a user enters values or instructions using the numeric keys 710-719, and makes corrections and adjustments using the “cancel” and “correct” keys. Once satisfied, the user submits an instruction by pressing the “enter” key 730. According to this embodiment, the enter key 730 integrates a sensor 731, which is able to derive biometric information from a user. When a user submits a transaction such as an instruction e.g. 212, 222, 232 as discussed above by depressing the “enter” key, biometric data are simultaneously read from the finger used to depress the key for submission as transaction authentication data 211, 221, 231 with the instruction data.

FIG. 10 shows a mouse 810 embodying the invention. The mouse is substantially conventional, comprising a body, a roller ball or optical motion sensor and a plurality of buttons 812, 820. According to this embodiment, mouse 810 integrates a sensor 821, which is able to derive biometric information from a user. The sensor 821 is preferably integrated in one of the mouse buttons. The sensor could also be located on the mouse frame, for example on the side part that is held by fingers to move it. So that it is not related only to the specific mouse button used by the application, so as always to be ready to be scanned, while the mouse is held. Still more preferably the sensor 821 is integrated in whichever of the mouse buttons is generally used in “submit” or “enter” type operations according to the operating environment with which the mouse provides interface functionality. a client-side system recognizes the biometric data that initiates each individual operation. This allows for a system that recognizes session initiation protocols, and allows further operations to be performed only by the same individual that initiated a session. That is, once a session is established, control from the peripheral device is passed onto the application only if the same identity (as defined by a characteristic biometric) is controlling the device. This method maintains the diffuse session-level authentication built into many mainstream applications, but adds transaction-level validation on top for additional security.

The Server System may host applications that are aware of transaction-level validation, or it may host applications that wholly depend on current levels of session-level authentication. In either case, it has a security structure based upon session-level authentication. It relies on the Secure Client System to ensure that once a session is started, each successive operation in that session is initiated by the authenticated party.

FIG. 11 shows a sixth embodiment. According to this embodiment operations are initiated by a peripheral device 20 such as the mouse described above with respect to FIG. 8. The device driver 30 for this device 20 reports not only the device operation e.g. 112, 122, 132, but communicates the identity 111, 121, 131 of the operation initiator or user 1, in the form of information derived by the sensor 821. The device driver 30 consults with a library component 35 to see whether the identity of the operation is the same as previous operations, or whether it is different. With this information the device driver 30 interfaces with the Transaction Execution Client 34, which is simply the client piece of the application. The application client may be intelligent enough to understand whether or not consecutive transactions require the same identity, or there may be a Transaction Signature Catalog 36 that defines which transactions require transaction level validation. Once the application client 923 is satisfied that the identity 211, 221, 231 of the transaction initiator is valid, then the transaction such as an operation e.g. 212, 222, 232 is propagated to the server system 5 for execution.

As discussed above, extraction of authentication data, such as biometric data is preferably linked to the initiation of a transaction, and is preferably triggered by the same user action which initiates the transaction. According to the embodiment of FIG. 11 therefore the capture of biometric data by the sensor 821 is preferably triggered by the actitivation of the left mouse button 820 into which the sensor 821 is integrated, on the basis that this button would be conventionally used to initiate a transaction.

The Transaction Signature Catalog 36 may be generated for example by adding an entry whenever a user ID is registered on a web-site application, or when signing up for a bank account together with a physical signature, or when a user ID and password pair are used for the first time.

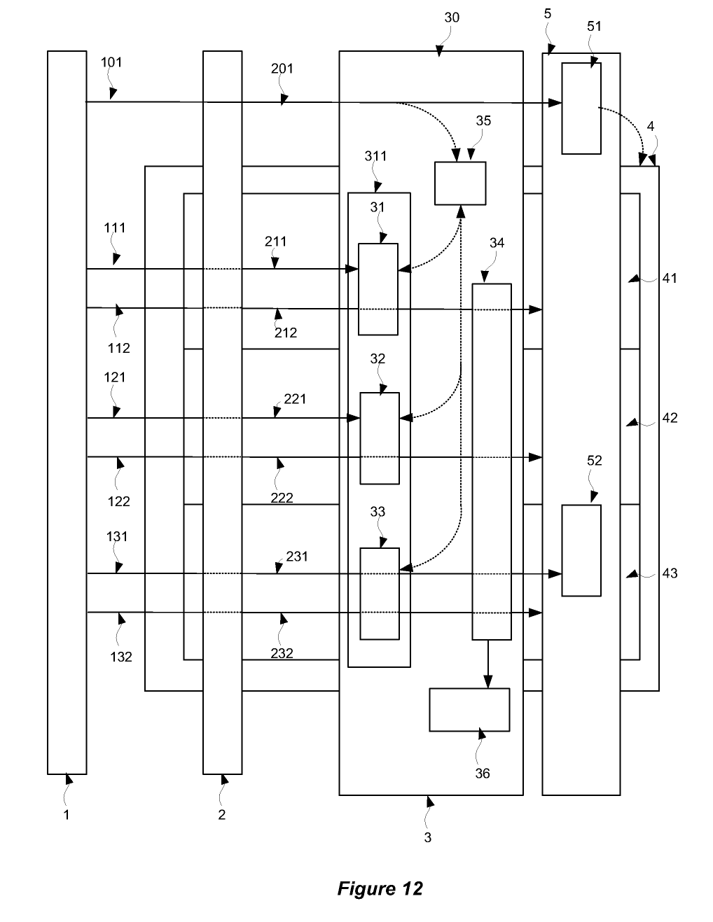

FIG. 12 shows in greater detail this sixth embodiment. FIG. 12 is similar to FIG. 7, and additionally provides a transaction signature catalogue 36 in communication with the Transaction Execution Client 34. As shown in FIG. 12, the session is initiated by server side authentication as discussed above. Thereafter, whenever a transaction message 212, 222, 232 is received at the client, the Transaction Execution Client 34 consults the transaction signature catalogue 36 to determine whether the requested transaction requires server level authentication, or whether client side authentication as discussed above is sufficient. As shown in FIG. 12, the transactions 212 and 222 are received and determined by the Transaction Execution Client 34 to belong to categories requiring merely delegated authentications, so that authentication and transaction processing proceeds as described with respect to FIG. 7. In the case of transaction 232 however, on referring to the transaction signature catalogue 36 the Transaction Execution Client 34 determines that full, server level authentication is required. Accordingly the transaction message 232 is relayed to the server together with the accompanying authentication message 231, so that authentication can be performed at the server 5 in authentication process 52, prior to transaction processing.

Where server side authentication is required, the library component may be refreshed or supplemented with the more recent authentication data. Where server side authentication is implemented, the transaction signature catalog 36 will preferably be present at the server. Server side authentication may be required for all transactions, in case of a system with an high level of protection (such as remote banking), or in case where the client and the server are owned by different entities that do not mutually trust each other, such as the case may be in WEB shopping where the client is the buyer's home PC and the server is the seller host. These situations may be contrasted with that of a teller machine, owned by the same bank, which will generally be a trusted client so that the user authentication may be performed locally at client level. The decision as to which approach to use will depend on the requested security level, the transaction types, the location and the topology of the clients.

Authentication is a relatively heavyweight process aimed at establishing to a very high standard that the person is who he/she claims to be. The checking of fingerprints for example for authentication purposes would be provides a trustworthy but onerous basis of authentication. Whilst within the scope of an authenticated session, where it is desired to check that the transactions are being initiated by the same user, the thoroughness of the comparison can be somewhat reduced. The fingerprint sample may contain a small number of reference points, for example, as a lightweight comparison with a subset of the full information is probably sufficient. It is extremely unlikely that a session on a particular computer be taken over by someone that has fingerprints similar enough to the original user to withstand even a lightweight comparison.

The preceding embodiments provide a number of different combinations of features. It should be understood that these features may be combined in many other ways.

Reference has been made in the above example to submitting instructions to a server. It will be understood that communications between different parts of the system will often be bidirectional, and that during a particular transaction a number of exchanges of information may occur in various directions between different system elements. These exchanges will often be provoked by a single command or set of related commands from a user however, and the term “instruction” is used with this in mind.

Similarly, transaction and authentication data are discussed in the preceding embodiments as separate entities. The skilled person will appreciate that they could also be part of the same transmitted data frame. They may be combined or separated at any stage.

The skilled person will appreciate that it will be desireable to take steps to ensure the security of parts of the system. For example, it may be necessary to secured and protect the transaction signature Catalog 36 for example by means of encryption.

Any element may be realised in terms of hardware, firmware, software or a combination of any or all of these. Where software components are provided, they may be placed temporarily or permanently on a carrier, such as an optical disc such as a CD or DVD, a magnetic disc such as a hard drive or floppy disc, a memory device such as a flash memory card, EPROM, volatile memory unit etc., or an optical, electrical, radio or other transmission channel, for example for the purposes of distribution.

1. A method of authenticating transactions, said method comprising the steps of:
initiating a session; said session comprising a
plurality of successive transactions, and
closing said session,
wherein each of said transactions comprises the steps of:
deriving transaction authentication data;
submitting an instruction accompanied by said transaction authentication data;
authenticating said instruction by an authentication process using said transaction authentication data; and
where said step of authenticating by a transaction authentication process is successful, processing said instruction.

2. The method of claim 1 wherein said transaction authentication data is derived substantially simultaneously with the initiation of an instruction.

3. The method of claim 1 wherein if said step of authenticating said instruction by said authentication process fails, said session is terminated without permitting the implementation of further transactions.

4. The method of claim 1 wherein a higher level of authentication and a lower level of authentication are defined, said method comprising the further step of determining whether for a particular instruction authentication should be implemented according said higher level or said lower level.

5. The method of claim 4 wherein said step of determining whether higher level authentication is required for a particular transaction is carried out with reference to a catalogue defining which instructions require higher level authentication.

6. The method of claim 3 wherein said step of initiating a session comprises a step of session authentication according to said higher level of authentication.

7. The method of claim 5 wherein said session authentication is a server side authentication.

8. The method of claim 4 wherein said lower level authentication process takes place at a clients, and wherein if said step of authenticating said instruction is carried out according to said lower level authentication process and succeeds, said instruction is relayed to a server for processing.

9. The method of claim 1 comprising the further step of storing said transaction authentication data for use in later authentications.

10. The method of claim 4 comprising the further step of storing said initiating authentication data for use in later authentications.

11. The method of claim 9 wherein said lower level of authentication comprises comparing authentication data submitted as part of an iteration of said transaction authentication process with said stored authentication data.

12. The method of claim 11 comprising the further step of determining to what degree it is required that said transaction authentication data submitted as part of an iteration of said second authentication process should match said stored authentication data.

13. The method of claim 11 wherein it is required that said transaction authentication data submitted as part of an iteration of said transaction authentication process should be identical to submitted with said stored authentication data.

14. The method of claim 1 wherein said authentication data is biometric data.

15. (canceled)

16. (canceled)

17. (canceled)

18. A mechanically actuated computer input device comprising a biometric data reader situated such that when said device is mechanically actuated by a user, said biometric data reader will be brought into a position so as to derive biometric data from said user.

19. A system for authenticating transactions, said system:
means for initiating a session; said session comprising a plurality of successive transactions,
means for closing said session,
means for deriving transaction authentication data for each of said transactions;
means for submitting an instruction accompanied by said transaction authentication data;
means for authenticating said instruction by an authentication process using said transaction authentication data; and
means for processing said instruction when the authentication process is successful.

20. A computer program product in a computer readable medium authenticating transactions, comprising:
instructions for initiating a session; said session comprising a plurality of successive transactions,
instructions for closing said session,
instructions for deriving transaction authentication data for each of said transactions;
instructions for submitting an instruction accompanied by said transaction authentication data;
instructions for authenticating said instruction by an authentication process using said transaction authentication data; and
instructions for processing said instruction when the authentication process is successful.
